(19) United States
(12) Patent Application Publication
(10) Pub. No.: US 2014/0280069 A1
(43) Pub. Date: Sep. 18, 2014

(54) Internet-Based Lot and Home Plan Suitability Matching System

(71) Applicant: Jeffrey A. Schoen, Grafton, WI (US)

(72) Inventor: Jeffrey A. Schoen, Grafton, WI (US)

(21) Appl. No.: 14/189,593

(22) Filed: Feb. 25, 2014

Related U.S. Application Data
(60) Provisional application No. 61/782,788, filed on Mar. 14, 2013.

(51) Int. Cl. G06F 17/30

(52) U.S. Cl. CPC G06F 17/30554
USPC 707/722; 707/758

(57) ABSTRACT

A method of matching building lots and home plans is provided. The method includes maintaining a first database having data for a plurality of building lots, and maintaining a second database having data for a plurality of home plans. The method further includes receiving a request, electronically submitted over a networked connection, for either a set of suitable building lots for a particular home plan, or a set of suitable home plans for a particular lot. The method also includes transmitting, over the networked connection, information showing either suitable building lots for a particular home plan, or suitable home plans for a particular lot.

### CROSS-REFERENCE TO RELATED PATENT APPLICATIONS

This patent application claims the benefit of U.S. Provisional Patent Application No. 61/782,788, filed Mar. 14, 2013, the entire teachings and disclosure of which are incorporated herein by reference thereto.

### FIELD OF THE INVENTION

This invention generally relates to networked systems for use in the sale of real estate.

### BACKGROUND OF THE INVENTION

Currently, the process of finding a lot for a particular home plan, or a home plan for a particular lot, is a manual process between a builder and home buyer, for example. Typically, a homebuilder will maintain a database of home plans suitable for a specific community or specific building lots. Typically, the link between home plan and lot, or between home plan and community, is done specifically for each pairing by the builder. Further, these builders so not generally provide options with respect to the lot type, and do nothing to verify that the home plan is suitable for a particular community.

Embodiments of the current invention overcome some of the aforementioned problems. These and other advantages of the invention, as well as additional inventive features, will be apparent from the description of the invention provided herein.

### BRIEF SUMMARY OF THE INVENTION

In one aspect, embodiments of the invention provide a method of matching building lots and home plans. The method includes maintaining a first database having data for a plurality of building lots, and maintaining a second database having data for a plurality of home plans. The method further includes receiving a request, electronically submitted over a networked connection, for either a set of suitable building lots for a particular home plan, or a set of suitable home plans for a particular lot. The method also includes transmitting, over the networked connection, information showing either suitable building lots for a particular home plan, or suitable home plans for a particular lot.

In particular embodiments, the method includes providing an illustration showing a home situated on a selected lot, and providing specifications for the home as situated on the selected lot, wherein the specifications include constructions costs for the home illustrated. Prior to transmitting information showing either suitable building lots for a particular home plan, or suitable home plans for a particular lot, the method may also include the step of considering data on legal requirements for a community in which a particular lot is located.

In another aspect, embodiments of the invention provide a system for matching building lots and home plans. The system includes a server connected to a network and configured to communicate with client computers. The server includes a first database having data for a plurality of home plans, and a second database having data for a plurality of building lots. Also, the server is configured to produce a set of suitable building lots for a particular home plan, and further configured to produce a set of suitable home plans for a particular lot.

In a particular embodiment, the server is configured to provide an illustration showing a home situated on a selected lot, or to provide illustrations showing a selected home plan situated on a lot. The server may also be configured to provide specifications for the home as situated on the selected lot, wherein the specifications include constructions costs for the home illustrated. In certain embodiments, the server includes data on legal requirements for a community in which a particular lot is located.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic block diagram depicting an interaction between an internet-based system and an end user, according to an embodiment of the invention;

FIG. 2 is a schematic block diagram depicting an interaction between an internet-based system and a builder, according to an embodiment of the invention;

FIG. 3 is a schematic block diagram showing the interaction between a server of the present invention interacts with its end users, in accordance with an embodiment of the invention;

FIG. 4 is an exemplary screen shot showing recommended home plans, according to an embodiment of the invention;

FIG. 5 is an exemplary screen shot showing recommended building lots, according to an embodiment of the invention; and

FIG. 6 is an exemplary screen shot showing photographs of recommended home plans, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

FIGS. 1-3 show schematic block diagrams which illustrate embodiments of the present invention. FIG. 1 is a block diagram depicting an interaction between an internet-based system and a prospective home buyer 108, according to an embodiment of the invention, while FIG. 2 is a block diagram depicting an interaction between an internet-based system and a builder 106, according to an embodiment of the invention. FIG. 3 is a block diagram which shows a particular example of how the various components of the present invention are connected. FIGS. 1-3 show a particular embodiment of the invention in which a computer server 102 is connected to end users via a networked connection, such as the internet 104. The server 102 may include, or be connected to a first database 112 having data on a plurality of home plans, and to a second database 114 having data on a plurality of building lots. The server 102 has system software 115 that includes algorithms for matching home plans and lots. End users may access, and receive information from, the server 102 using personal computers or mobile electronic devices, such as tablets or smartphones. The second database 114 may also include the lot characteristics 116 and specifications associated with each of the plurality of building lots, along with legal information such as community restrictions 118 and local or municipal restrictions 120 (e.g., municipal or county restrictions on building), zoning ordinances, permit requirements, etc.

Data on the plurality of home plans and building lots may be collected from builders supporting the system. More specifically, for-sale lot information and criteria may be input into the system through various sources of real estate information 109 (e.g., MLS, other real estate websites, government data, developers, builders, etc.) obtained via the network 104. Information and criteria for home plans information may be input into the server 102 through various sources of real estate information 109 related to home plans such as might available from builders, contractors, and architects, for example. Community information, ordinances, and community and municipal restrictions 118, 120 may be input into the server 102 through various community sources (e.g., government agencies, MLS, developers, builders, etc.). The server 102 is designed to take all of these criteria, either entered manually into the server 102 or imported from other sources, and to store this information into the specially configured first and second databases 112, 114 of the present invention.

In response to requests from end users, home buyers 108 for example, or builders 106, the server 102 can supply a listing and relevant details for a listing of recommended lots 122 matched to a particular home plan supplied by the end user or builder 106. In a particular embodiment, the server 102 may also be configured to supply a website home plan detail listing page 126, which provides detailed information on the home plan suitable for the list of recommended lots 122. Additionally, the server 102 is configured to supply a list of suitable home plans 124 matched to a particular building lot provided by the end user or builder. In a particular embodiment, the server 102 may also be configured to supply a lot detail listing page 128, which provides detailed information on the lot on which the list of recommended home plans 124 can be built, and further configured to supply a community detail page 130 showing the relevant community and/or municipal restrictions. In certain embodiments, the sever 102 is configured to provide a range of information and specifications concerning the home plan and building lot matched by the server 102. The specifications may include, but are not limited to construction costs, project timelines, required inspections, etc.

In operation, based on a set of criteria/characteristics input from either a web-based end user, stored building lot data, or home plan data, the server 102 will provide a list of suitable matching lots or home plans. For example, a web-based end user, a home buyer for example, looking at a specific lot, either already owned or perhaps found on an internet website or in a newspaper, may submit a request for the server 102 to provide a list of suitable home plans 124 that can be built on this lot. Additional lot/home plan criteria entered by the web-based end user can further narrow the list of suitable home plans 124. For example, the web-based end user may have a specific home plan found via an internet website or by other means. The user can electronically submit a request over the internet 104 for the system to provide a list of suitable lots 122 where this home plan can be built. Additional lot/home plan criteria, entered by the web-based end user, can further narrow the list of suitable lots 122.

In another example, a web-based end user can enter their own home plan criteria/characteristics into the server 102. The server 102 will then provide a list of recommended lots 122 that are suitable matches to build this home plan. Additional lot criteria, entered by the web-based end user, can further narrow the list of suitable lots 122. For example, a web-based end user can enter their own lot criteria/characteristics into the system. The server 102 will then provide a list of recommended home plans 122 that are suitable matches to build on the suitable lot. Additional home plan criteria entered by the web-based end user can further narrow the list of suitable home plans 122.

FIGS. 4-6 each show exemplary screen shots as would be seen by the end users (i.e., builders 106, home buyers 108). FIGS. 4 and 6 each shows an exemplary screen shot with a list of recommended home plans 124 (shown in FIGS. 1 and 2) and photographs of the home plans for a particular lot whose details have been entered into the server 102. The list of recommended home plans 124 is provided in response to requests submitted from a home builder 106 or home buyer 108, for example, via the internet 104 (shown in FIG. 3). The screen shot of FIG. 6 may also include property details for the lot, along with various property details for each of the recommended home plans including, but not limited to, photographs, artist renderings, and floor plans, for example.

FIG. 5 shows exemplary screen shot of a list of recommended building lots 122 (shown in FIGS. 1 and 2) for a particular home plan whose details have been entered into the server 102. The list of recommended building lots 122 is provided in response to requests submitted from a home builder 106 or home buyer 108, for example, via the internet 104 (shown in FIG. 3). The screen shot of FIG. 5 may also include property details for home plan for which the list of recommended building lots 122 is generated. The screen shot of FIG. 5 may also include photographs and/or zoning restrictions, or other legal information regarding the lot. As can be seen from FIGS. 4-6, the server 102 (shown in FIG. 3) may be configured to provide a variety of relevant information in addition to that specifically described above and shown in the drawings with respect to the various home plans and building lots matched by the system described herein.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for matching building lots and home plans, the system comprising:
a server connected to a network and configured to communicate with an end user device;
wherein the server includes a first database having data for a plurality of home plans, and a second database having data for a plurality of building lots, the server being configured to produce a set of suitable building lots for a particular home plan, and further configured to produce a set of suitable home plans for a particular lot.

2. The system of claim 1, wherein the server is configured to provide an illustration showing a home situated on a selected lot, or to provide illustrations showing a selected home plan situated on a lot.

3. The system of claim 2, wherein the server is further configured to provide specifications for the home as situated on the selected lot, wherein the specifications include constructions costs for the home illustrated.

4. The system of claim 1, wherein the server includes data on legal requirements for a community in which a particular lot is located.

5. The system of claim 1, wherein the end user device is a personal computer.

6. The system of claim 1, wherein the end user device is one of a tablet computer and a smartphone.

7. A method of matching building lots and home plans, the method comprising:
maintaining a first database having data for a plurality of building lots;
maintaining a second database having data for a plurality of home plans;
receiving a request, electronically submitted over a networked connection, for either a set of suitable building lots for a particular home plan, or a set of suitable home plans for a particular lot; and
transmitting, over the networked connection, information showing either suitable building lots for a particular home plan, or suitable home plans for a particular lot.

8. The method of claim 7, further comprising:
providing an illustration showing a home situated on a selected lot; and
providing specifications for the home as situated on the selected lot, wherein the specifications include constructions costs for the home illustrated.

9. The method of claim 7, further comprising maintaining information on legal and community restrictions for one or more communities.

10. The method of claim 9, wherein prior to transmitting information showing either suitable building lots for a particular home plan, or suitable home plans for a particular lot, the method further comprises the step of considering the information on legal and community restrictions for a community in which a particular lot is located.

11. The method of claim 7, wherein transmitting, over the networked connection, information showing either suitable building lots for a particular home plan, or suitable home plans for a particular lot comprises transmitting to a personal computer of an end user.

12. The method of claim 7, wherein transmitting, over the networked connection, information showing either suitable building lots for a particular home plan, or suitable home plans for a particular lot comprises transmitting to a mobile electronic device of an end user.
